(19) United States
(12) Patent Application Publication
(10) Pub. No.: US 2008/0176692 A1
(43) Pub. Date: Jul. 24, 2008

(54) Belt-driven transmission

(75) Inventor: Andre Teubert, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/002,308

(22) Filed: Dec. 15, 2007

Related U.S. Application Data
(60) Provisional application No. 60/875,014, filed on Dec. 15, 2006.

(51) Int. Cl. F16G 13/02; F16G 13/04; F16H 55/56; F16H 7/22; B62J 13/00

(52) U.S. Cl. 474/206; 474/214; 474/8; 474/119; 474/144

(57) ABSTRACT

A belt-driven transmission having an endless torque-transmitting member that is operatively connected with two power transmitting elements. The transmission includes at least one guide rail assembly that engages the endless torque-transmitting member with free play and that has an outer guide rail and an inner guide rail so that the endless torque-transmitting member runs within a guide rail channel defined by the outer and inner guide rails of the guide rail assembly. The endless torque-transmitting member includes one surface that is at least partially provided with outwardly-extending tabs and another, tab-free surface. The guide rail assembly is pressed against the endless torque-transmitting member on the tab-free surface to limit vibratory amplitude of the endless torque-transmitting member during operation of the transmission.

### BACKGROUND OF THE INVENTION

1. Field of the Invention

The present invention relates to a belt-driven transmission.

2. Description of the Related Art

Belt-driven transmissions, for example variable speed drive transmissions (CVT transmissions), are provided with guide rails that suppress strand vibrations, in order to inhibit vibrations of the endless torque-transmitting means that cause unwanted sound emissions. A transmission of this sort is revealed for example in published German patent application DE 103 57 169. The guide rails form a channel in which the endless torque-transmitting means—usually a chain—runs almost without friction. If vibrations occur, the channel limits them before significant amplitudes can develop.

The vibrations of the endless torque-transmitting means can cause wear to develop on the guide rails. That not only endangers the service life or strength of the guide rails themselves, but in addition the resulting abraded particles can cause damage to the transmission, for example by clogging filters or the like. In the case of CVT transmissions having plate-link chains, chains are known that have tabs (assembly tabs) to simplify assembly. The tabs are situated within the installed plate-link chain so that they are all on one side. Such tabs increase wear further.

An object of the present invention is therefore to reduce the wear on a guide rail when using an endless torque-transmitting means having tabs on one side.

### SUMMARY OF THE INVENTION

The object is achieved by a belt-driven transmission having an endless torque-transmitting means that is operatively connected with two torque transmitting elements, wherein the belt-driven transmission includes at least one guide rail assembly that engages the endless torque-transmitting means but that allows some play. An outer guide rail and an inner guide rail are positioned to define a guide rail channel so that the endless torque-transmitting means runs within the guide rail channel provided by the guide rail assembly. The endless torque-transmitting means includes one side that is at least partially provided with tabs and one side that is tab-free. The guide rail assembly is pressed against the endless torque-transmitting means on the tab-free side of the endless torque-transmitting means, and is situated between the torque transmitting elements, i.e., in a region in which the endless torque-transmitting means otherwise runs without guidance.

The guide rail assembly includes an outer guide rail and an inner guide rail, between which a guide rail channel is formed. The guide rails are preferably components of synthetic material, or metal parts provided with a synthetic runway surface. The guide rail assembly is pressed against the endless torque-transmitting means with the guide rail that is on the tab-free side of the endless torque-transmitting means. A preferred embodiment includes the provision that the endless torque-transmitting means is in the form of a plate-link chain and includes a large number of plates, and at least individual plates are provided with tabs. The plates provided with tabs are oriented so that one face of the plate-link chain includes the tabs and the opposite face is tab-free. Preferably, provision is made for the torque transmitting elements to be conical pulleys that include two conical disks.

A preferred embodiment includes the provision that the belt-driven transmission is a variable speed drive transmission with two conical pulleys, each of which includes two conical disks whose axial spacing can be shifted relative to each other. Preferably, the guide rail assembly is pressed against the endless torque-transmitting means by a spring. Preferably a damper is situated in parallel with the spring. The guide rail assembly is preferably movably supported for movement in a direction perpendicular to the chain running direction. Because of its movability, the guide rail assembly can be pressed against the endless torque-transmitting means by a spring of low spring stiffness. Preferably, provision is made for the guide rail assembly to be supported so that it is rotatable about an axis of rotation, which allows strand vibrations in the endless torque-transmitting means to also be disrupted or damped by a tilting motion of the guide rail assembly about the axis of rotation.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic side view of an embodiment of a variable speed drive transmission in accordance with the present invention;

FIG. 2 is a top view of the variable speed drive transmission shown in FIG. 1;

FIG. 3 is an enlarged, longitudinal cross-sectional view of the guide rail assembly shown in FIG. 1.

### DESCRIPTION OF THE PREFERRED EMBODIMENTS

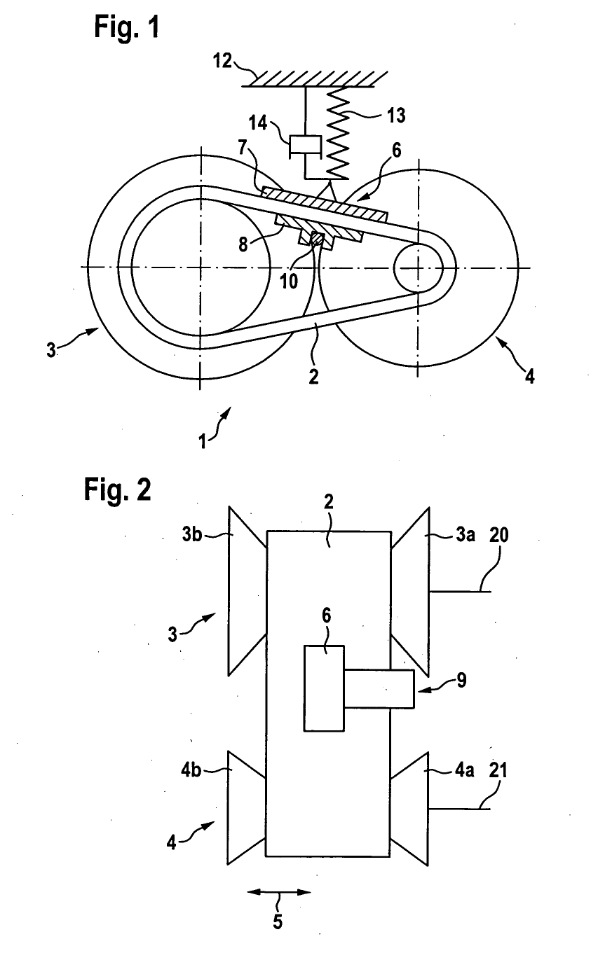

FIG. 1 shows a schematic representation of a variable speed drive transmission 1, also known as a CVT transmission (continuously variable transmission) in a side view, and FIG. 2 shows a top view. The variable speed drive transmission 1 includes an endless torque-transmitting means 2, which is operatively connected to a first conical pulley 3 and to a second conical pulley 4. As shown in FIG. 2, conical pulley 3 includes an axially fixed conical disk 3a and a conical disk 3b that is axially movable in the direction of the double arrow 5. Correspondingly, second conical pulley 4 includes an axially fixed conical disk 4b and an axially movable conical disk 4a that is axially movable in the direction of the double arrow 5. Endless torque-transmitting means 2 is frictionally engaged with conical disks 3a, 3b, 4a, 4b.

Conical pulley 3 is connected to an input or output shaft 20; correspondingly, conical pulley 4 is connected to an input or output shaft 21. Changing the axial spacing between the conical disks of the conical pulleys changes the transmission ratio between the input and output shafts 20, 21 continuously. The endless torque-transmitting means 2 is a plate-link chain, in this case a rocker joint chain. The rocker joint chain includes rocker members whose end faces are in contact with conical disks 3a, 3b, 4a, 4b and form a frictional connection with them to transfer torque between the two conical pulleys 3, 4.

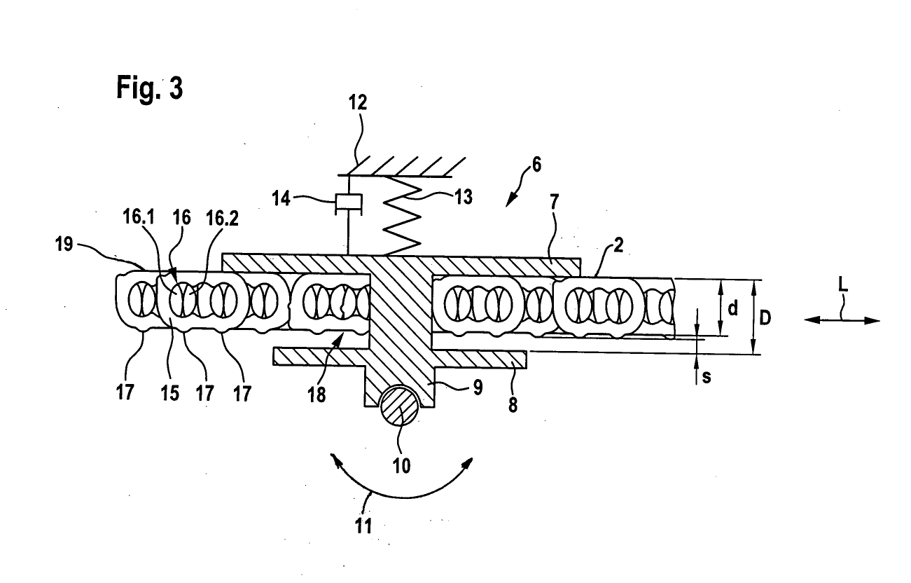

A guide rail assembly 6, which is shown in greater detail in FIG. 3 than in FIG. 1, is situated between the two conical pulleys 3, 4 to reduce strand vibrations. Guide rail assembly 6 includes an outer guide rail 7 and an inner guide rail 8, which are firmly connected to each other at a predetermined fixed spacing by means of a guide rail support 9. Between the spaced, parallel guide rails 7, 8 a guide rail channel 18 is formed, whose radial clear height D, in a radial direction relative to the axes of shafts 20, 21, is greater than the radial height d of the endless torque-transmitting means 2, so that a radial free play distance s exists between endless torque-transmitting means 2 and guide rail assembly 6.

On the radially inner side of guide rail assembly 6, guide rail support 9 is supported on a guide pin 10 that extends in a direction perpendicular to chain running direction L. Guide rail assembly 6 is mounted so that it can pivot about the axis of guide pin 10, in the directions indicated by double-headed arrow 11 in FIG. 3. A spring 13 extends between a support 12, which is firmly attached to the transmission housing, and guide rail assembly 6. Spring 13 is connected to guide rail assembly 6 in such a way that outer guide rail 7 is pressed against the radially upper surface of endless torque-transmitting means 2. To that end, spring 13 can be situated as a pressure spring between housing-mounted support 12 and outer guide rail 7, as shown in FIG. 3. Other arrangements are also conceivable, however to exert a force on guide rail assembly 6 such that outer guide rail 7 is pressed in the direction of endless torque-transmitting means 2. A damping element 14 can be positioned parallel to spring 13, as indicated schematically in FIGS. 1 and 3, and it can be a viscous damper or a friction damper.

Outer guide rail 7 is urged into contact with endless torque-transmitting means 2 by spring 13. The stiffness of spring 13 is chosen so that only a slight pressure is exerted, so that the wear on each of the contacting surfaces of endless torque-transmitting means 2 and outer guide rail 7 is limited.

Endless torque-transmitting means 2 is shown as a plate-link chain with a large number of plates 15 which are hingedly joined with each other by rocker joints 16, each of which includes two rocker members 16.1, 16.2. The plates 15 have an edge on which tabs 17 are situated, and a tab-free edge 19 on which no tabs are situated. In the present exemplary embodiment, the edge of the endless torque-transmitting means 2 on which the tabs 17 of the plates 15 are located is the radially inner side of endless torque-transmitting means 2, i.e., the side that lies radially inward when the endless torque-transmitting means encircles the conical pulleys 3, 4. In this case guide rail assembly 6 is pressed against endless torque-transmitting means 2 on its surface defined by tab-free edges 19, which is the radially outwardly facing surface in this case.

The opposite case is equally conceivable, however, i.e., for the tab-free surface of the endless torque-transmitting means to be located on the radially inner side. In that case, in the representation shown in FIG. 3 the tab-free surface would be in contact with the inner guide rail 8. In this case also, guide rail assembly 6 would be pressed against the tab-free surface, and in the representation shown in FIG. 3 the inner guide rail 8 would then be urged into contact with endless torque-transmitting means 2. A guide rail assembly 6 can be situated both in the tension strand and also in the slack strand of the endless torque-transmitting means 2; likewise, both the tension strand and the slack strand can each include a guide rail assembly 6.

The result of spring-loading guide rail assembly 6 is that in operating states without vibrations, guide-rail assembly 6 by definition touches endless torque-transmitting means 2 on only one surface, in the present exemplary embodiment the tab-free radially outer surface of the endless torque-transmitting means. Thus, there is a gap between the radially inner surface of the endless torque-transmitting means and the adjacent surface of inner guide rail 8. The pressure imposed by spring 13 is selected so that the wear or friction between the surface of outer guide rail 7 that bears against endless torque-transmitting means 2 and the tab-free surface of endless torque-transmitting means 2 is increased only slightly. The result is that in the predominant operating states endless torque-transmitting means 2 contacts guide rail 7 only with its radially upper surface, which because of its smooth geometry clearly imposes a lower load on upper guide rail 7. As a result there is less wear on upper guide rail 7 than with known solutions according to the existing art.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A belt-driven transmission having an endless torque-transmitting means that is operatively connected with two transmitting elements, said transmission comprising: at least one guide rail assembly that includes an outer guide rail and an inner guide rail spaced from the outer guide rail at a guide rail spacing distance to define therebetween a guide rail channel within which the endless torque-transmitting means runs; wherein the endless torque-transmitting means includes a first surface that includes outwardly extending tabs and a second surface opposite from the first surface and that is free of tabs, wherein the first and second surfaces of the endless torque-transmitting means are spaced from each other a distance greater than the guide rail spacing distance to provide a free play region within the guide rail channel; and biasing means for urging the guide rail assembly against the second surface of the endless torque-transmitting means to limit vibration amplitude of the endless torque-transmitting means during operation of the transmission.

2. A belt-driven transmission in accordance with claim 1, wherein the endless torque-transmitting means is a plate-link chain and includes a plurality of side-by-side plates, wherein at least individual ones of the plates are provided with outwardly-extending tabs, the plates provided with tabs being oriented in the plate-link chain so that an edge of the plate-link chain provided with tabs and a tab-free edge of the plate-link chain are formed.

3. A belt-driven transmission in accordance with claim 2, wherein the transmitting elements are conical pulleys, each of which includes two conical disks.

4. A belt-driven transmission in accordance with claim 3, wherein the belt-driven transmission is a variable speed drive transmission with two conical pulleys, each of which includes two pairs of conical disks and wherein one conical disk of a disk pair is axially movable relative to the other conical disk of that disk pair to change the axial spacing between the conical disks of a conical disk pair.

5. A belt-driven transmission in accordance with claim 4, wherein the biasing means for urging the guide rail assembly against the endless torque-transmitting means is a spring.

6. A belt-driven transmission in accordance with claim 5, including a damping member positioned parallel to the spring for damping spring movements during operation of the transmission.

7. A belt-driven transmission in accordance with claim 1, wherein the guide rail assembly is supported on a support member that extends in a direction that is perpendicular to the chain running direction.

8. A belt-driven transmission in accordance with claim 7, wherein the guide rail assembly is supported so that it is tiltable relative to the support member and about an axis that is perpendicular to the chain running direction.
